(19) United States
(12) Patent Application Publication
(10) Pub. No.: US 2005/0174600 A1
(43) Pub. Date: Aug. 11, 2005

(54) Image output system, image supply device, image output device, and image output method

(75) Inventors: Yoshinao Kitahara, Nagano (JP); Hideki Morozumi, Nagano (JP); Kenji Sakuda, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/008,162

(22) Filed: Dec. 10, 2004

(30) Foreign Application Priority Data
Dec. 11, 2003 (JP) P2003-413399
Nov. 10, 2004 (JP) P2004-326028

(51) Int. Cl. G06F 15/00

(52) U.S. Cl. 358/1.15

(57) ABSTRACT

Even in case of employing a descriptive rule designated of one image data file to one image of the image output object in the image output request, it is possible to realize an image output process of outputting one image by using a plurality of data files and enables. An image supply device transmits to an image supply device an image output request designating, as an image data file, a plurality of data files used for a determined image output form of outputting one image by use of the plurality of data files. The image output device acquires parts or all of the plurality of data files designated in the image output request from the image supply device, and in case the data file has a determined form, the image output device acquires remaining data files if still existing from the image output device, and outputs one image in the above determined image output form based on the plurality of data files designated in the image output request.

### BACKGROUND OF THE INVENTION

The present invention relates to an image output system and an image output method of transferring an image output request and a data file designated by this image output request from an image supply device to an image output device, and outputting images on the basis of the image output request and the data file, and further the invention relates to the image supply device and an image output device available to the image output system and the image output method.

So-called direct print system has recently been developed, where a digital still cameral device and a printer are directly connected, not via a personal computer, to transfer to the printer an image data file stored in the digital still cameral device, and to generate print control data from the image data file by the printer device for printing the image. For example, there is a literature mentioned under.

Non-Patent Literature 1:

Refer to “White Paper of CIPA DC-001-2003 Digital Photo Solutions for Imaging Devices (Japanese)” Camera digital camera device Imaging Products Association of Feb. 3, 2002.

There has conventionally been the image output method called as a frame inserting print which carries out prints by superposing the frame image on the image of the image data file. In the frame inserting print, on the basis of a plurality of data files such as the image data file or a layout definition file defining the frame image, one image is printed by superposing the frame image on the image of the image data file. As such a frame inserting print, there is PIF (PRINT Image Framer) by the same applicant of this application.

In regard to the above mentioned direct printing, in the print request transferred from the digital still cameral device to the printer device, ordinarily, one image data file is designated to one image of objects to be printed. Therefore, in case of using a plurality of data files to the print of one image as the above mentioned frame inserting print, it is necessary in the printing request to revise a descriptive rule of the printing request in order to response to such an especial case. A revising work is probably very complicated because of exchangeability occurring before and after the revising work. Especially, in case the descriptive rule is used to a plurality of venders or standardized, such problems are conspicuous. This matter occurs similarly in other image outputs than printing.

In view of the above mentioned problems, the present invention has been made, and accordingly it is an object of the invention to provide an image output system and an image output method which, even in case of employing a descriptive rule designated of one image data file to one image of the image output object in the image output request, uses a plurality of data files and enables to realize an image output process of outputting one image, and as well as an image supply device and an image output device available to the image output system and the image output method.

### SUMMARY OF THE INVENTION

For solving the above mentioned problems, the image output method of the present invention is an image output method of transferring an image output request and a data file designated by said image output request from an image supply device to an image output device, and outputting an image on the basis of the image output request and the data file by said image output device, comprising a step of transmitting to said image output device the image output request designating, as the data file, a plurality of data files used for an image output form of outputting one image by using a plurality of data files by means of said image supply device; a step of, on receiving said image output request by means of said image output device, acquiring parts or all of the plurality of data files designated in the image output request from said image supply device; and a step, if the acquired data files have a determined form, acquiring the remaining data files if existing from the image output device by means of said image output device, and outputting one image in the image output form on the basis of the plurality of data files designated in the image output request.

Thereby, even in case of employing a descriptive rule designated of one image data file to one image of the image output object in the image output request, if designating the plurality of mutually relative data files by the plurality of image output requests, it is possible to use a plurality of data files and enable to realize an image output process of outputting one image.

Further, the image output method of the present invention allows the following manner in addition to the above mentioned image output method. In short, when generating the image output request for outputting the image in said image output form, the image output method of the invention sets in default a file form information designating the form of the data files designated in the image output request by the image supply device.

Thereby, if setting in the default the data file designated by the image output request as to the image output process of outputting one image by using the plurality of data files, since the set in the default ordinarily exists in the existing descriptive rule, it is unnecessary to clearly describe the image output process of outputting one image by using the plurality of data files, and the image output request can be described in the existing descriptive rule.

Further, the image output method of the present invention allows the following manner in addition to any of the above mentioned image output method. In short, when setting in default the file form information designating the form of the data file designated in said image output request, the image output method of the invention acquires parts or all of the plurality of data files designated in the image output request through communication means from said image supply device by means of said image output device, and when the acquired data files have the determined form, the invention acquires the remaining data files if existing, through the communication means from the image supply device by means of said image output device, and controls said image output means so as to output one image in said image output form on the basis of the plurality of data files designated in said image output request.

Thereby, if setting in the default the data file designated by the image output request as to the image output process of outputting one image by using the plurality of data files, since the set in the default ordinarily exists in the existing descriptive rule, it is unnecessary to clearly describe the image output process of outputting one image by using the plurality of data files, and the image output request can be described in the existing descriptive rule.

Further, the image output method of the present invention allows the following manner in addition to any of the above mentioned image output method. In short, the invention designates, as a plurality of data files used for the image output form of outputting an image superposing a certain main image and a certain frame image, a layout definition file including layout information of the main image and the frame image, the data file of said frame image, and the data file of said main image in said image output request by means of said image supply device.

Thereby, even in case of employing a descriptive rule designated of one image data file to one image of the image output object in the image output request, it is possible to realize the image output of superposing the frame image on the main image and outputting it in such as the frame inserting print.

Further, the image output method of the present invention allows the following manner in addition to any of the above mentioned image output method. When designating the layout definition file including the layout information of the main image and the frame image among the plurality of data files used for outputting the image superposing the main image and a frame image in said image output request, the invention controls the image output means on the basis of the data file, the image data file of the main image designated in the image output request and the data file of the frame image by means of the image output devices so as to output one of images superposing the frame image on the main image.

Thereby, even in case of employing a descriptive rule designated of one image data file to one image of the image output object in the image output request, it is possible to realize the image output of superposing the frame image on the main image and outputting it in such as the frame inserting print.

An image output system of the invention comprises an image supply device of transmitting an image output request and a data file designated by the image output request, and an image output device receiving the image output request and the data file designated by the image output request so as to output the image on the basis of the image output request and the data file. The image supply device transmits to the image output device the image output request designating, as the image data file, a plurality of data files used for an image output form of outputting one image by using a plurality of data files. On the other hand, when receiving said image output request, the image output device acquires parts or all of the plurality of data files designated in the image output request from said image supply device, and when the acquired data files have a determined form, acquires remaining data files if existing from the image supply device, and outputs one image in said image output form on the basis of the plurality of data files designated in said image output request.

Thereby, even in case of employing a descriptive rule designated of one image data file to one image of the image output object in the image output request, if designating the plurality of mutually relative data files by the plurality of image output requests, it is possible to use a plurality of data files and enable to realize an image output process of outputting one image.

An image supply device of the invention receives an image output request and a data file designated by said image output request, and transmits said image output request and said data file to the image output device outputting an image on the basis of said image output request and said data file, and comprises communication means of carrying out data communications in relation with said image output device, and communication control means of controlling said communication means, and transmitting to said image output device the image output request designating, as an image data file, the plurality of data files used for a image output form outputting one image by using the plurality of data files.

Thereby, even in case of employing the descriptive rule designated of one image data file to one image of the image output object in the image output request in the image output system using this image supply device, if designating the plurality of mutually relative data files by the plurality of image output requests, it is possible to use a plurality of data files and enable to realize an image output process of outputting one image.

An image output device of the invention receives an image output request and a data file designated by the image output request from an image supply device, and outputs an image on the basis of said image output request and said data file, and comprising communication means of carrying out data communications; image output means of outputting one image on the basis of a plurality of data files in accordance with a determined image output form; and control means which, when receiving said image output request by said communication means, acquires parts or all of the plurality of data files designated in the image output request through communication means from said image supply device, and when the data files have a determined form, acquires the remaining data files if existing through said communication means from the image supply device, controls said image output means, and outputs one image in said image output form on the basis of the plurality of data files designated by said image output request.

Thereby, even in case of employing the descriptive rule designated of one image data file to one image of the image output object in the image output request in the image output system using this image supply device, if designating the plurality of mutually relative data files by the plurality of image output requests, it is possible to use a plurality of data files and enable to realize an image output process of outputting one image.

An image output system of the invention comprises an image supply device of transmitting an image output request and a data file designated by said image output request, and an image output device of receiving the image output request and the data file designated by said image output request so as to output the image on the basis of the image output request and the data file. The image supply device transmits to said image output device the image output request designating, as the image data file, a plurality of data files used for an output form of outputting a still image and a dynamic image or an image and a voice in parallel by use of a plurality of data files. The image output device, when receiving said image output request, acquires one part or all of the plurality of data files designated in the image output request from said image supply device, and when the acquired data files have a determined form, acquires remaining data files if existing from the image supply device, and outputs the still image and the dynamic image or the image and the voice in parallel in said image output form on the basis of the plurality of data files designated in said image output request.

Even in case of adopting the descriptive rule of designating one image data file to one image of the image output object in the image output request, depending on the invention, it is possible to realize the image output process of outputting one image, using the plurality of data files.

The present disclosure relates to the subject matter contained in Japanese patent application Nos. 2003-413399 (filed on Dec. 11, 2003) and 2004-326028 (filed on Nov. 10, 2004), each of which is expressly incorporated herein by reference in its entirety.

### BRIEF DESCRIPTION OF THE DRAWINGS

FIG. 1 is a block diagram showing the structure of the image output system of the embodiment of the invention;

FIG. 2 is a block diagram showing the structural example of the hard ware of the printer device in the image output system of the embodiment of the invention;

FIG. 3 is a block diagram showing the structural example of the hard ware of the digital camera in the image output system of the embodiment of the invention;

FIGS. 4A and 4B are views showing examples of protocols used between the printer device and the digital camera device in the image output system of the embodiment of the invention;

FIG. 5 is a view for explaining the concept of PIF function;

FIG. 6 is a view showing examples of printing images of the PIF print;

FIG. 7 is a view showing examples of the layout definition file;

FIGS. 8A and 8B are views showing examples of the XML script and set example of the data file of the image output request used when PIF printing in the image system of the embodiments of the invention; and

FIG. 9 is a flow chart for explaining the work of the printer device in the image system of the embodiments of the invention.

### DESCRIPTION OF THE PREFERRED EMBODIMENT

Explanation will be made to embodiments of the invention on the basis of the attached drawings.

Embodiment 1

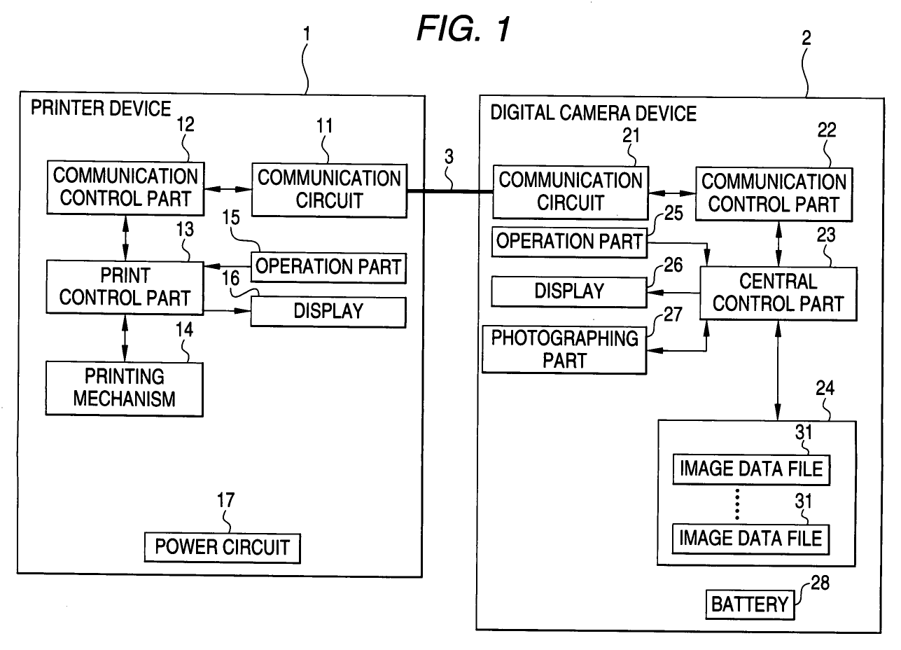

FIG. 1 is a block diagram showing the structure of the image output system of the embodiment 1 of the invention. The image output system is one kind of so-called direct printing systems. In FIG. 1, a print device 1 is one embodiment of the image output device of the invention, and is a device which receives the image output request and the image data file, and carries out printings on the basis of the image output request and the image data file. A digital camera device 2 is one embodiment of the image supply device of the invention, and is a device which stores a photographed image as the image data file in a determined record medium, and outputs the image output request and the image data file designated by the image output request.

The image output request is a control command for causing the print device 1 to carry out printings under desired printing conditions, and one image data file per one image is designated. Accordingly, for example, in case of printing four images on one sheet of a printing paper, ordinarily four image data files are designated.

A channel 3 is a wire transmission medium connecting the printer device 1 and the digital camera device 2. The channel 3 is not limited to the wired channel, and a wireless channel may be also used. This embodiment 1 employs a cable of USB (Universal Serial Bus). By the way, if the channel 3 is the wired channel, the printer device 1 and the digital camera device 2 are provided with a connector (not shown), and connectors at both ends of the cable of the channel 3 and connectors of both devices 1, 2 are connected respectively.

In the printer device 1 shown in FIG. 1, a communication circuit 11 transmits and receives various kinds of information as electric signals via the channel 3. A communication control part 12 is a circuit or a device of controlling the communication circuit 11, and transmitting and receiving control information (control command, response thereto, or notification of conditions of a machine or job) and image data files with communication partners in accordance with protocols, and image data files.

In the printer device 1, a print control part 13 is a circuit or a device for controlling and observing a printing mechanism 14, and controlling a printing process. The printing mechanism 14 is a mechanical and/or electrical structured part for outputting images. As the printing mechanism 14 of the printer device 1, a printing or a paper feed mechanism are pertinent. By the print control part 13 and the printing mechanism 14, the printing means of printing images according to the image data file is structured.

In the printer device 1, an operation part 15 is a circuit or a device operated by a user for outputting signals in response to the operation. As the operation part 15, several kinds of switches or touch switches are appropriately used. A display 16 is a device for showing various kinds of information. As the display 16, indicators or liquid crystal displays are appropriately used. A power circuit 17 is connected to, e.g., a commercial power source or AC/DC converter, and supplies power to an internal circuit.

In the digital camera device 2 shown in FIG. 1, a communication circuit 21 transmits and receives various kinds of information as electric signals via the channel 3. A communication control part 22 is a circuit or a device of controlling the communication circuit 21, and transmitting and receiving control information with communication partners in accordance with protocols. A central control part 23 is a circuit or a device of executing various kinds of processes while transmitting and receiving information in relation with a circuit or a device of many kinds of functions of the communication control part 22 or the record medium 24.

In addition, in the digital camera device 2, the record medium 24 is a device for storing one or a plurality of image data files 31 including the image data. The image data file 31 is a file including, for example, images photographed by the digital camera or image data of other images. A form of the image data is, for example, JPEG (Joint-Photographic Experts Group) or EXIF (Exchangeable Image File).

As the record medium 24, there are a semi-conductor memory, a memory card using the semi-conductor memory, a magnetic record medium, an optical record medium, or an optically magnetic record medium, and those may be secured inside of the digital camera device 2 or are detachably attached thereto.

Besides, in the digital camera device 2, an operation part 25 is a circuit or a device operated by the user for outputting signals in response to the operation. As the operation part 25, several kinds of switches or touch switches are appropriately used. A display 26 is a device for showing various kinds of information based on the image data. As the display 26, indicators or liquid crystal displays are appropriately used. The display 26 functions as the display means showing menu having setting items of various kinds of functions. In case the set items are shown in a determined code, menu items corresponding thereto use a text showing these items.

In the digital camera device 2, a photographing part 27 is a mechanism or a device having photographing elements of optical system as lenses or CCD (Charge Coupled Device) for photographing objects, and outputting image data corresponding to the photographed image.

A battery 28 is a cell for supplying power to an internal circuit of the digital camera device 2. As the battery 28, a storage battery or a disposable battery are used. In case the digital camera device 2 is a device requiring transportability, the battery 28 is furnished as the power source, but if the digital camera device 2 is a device not requiring transportability, a power circuit such as the power circuit 17 of the print device 1 may be instead furnished, and the power supply may be received via the channel 3 from the print device 1.

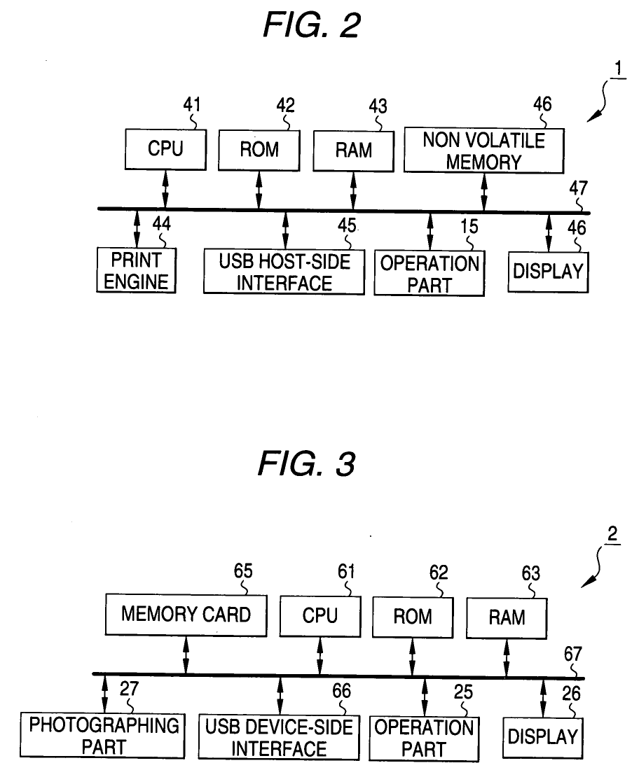

FIG. 2 is a block diagram showing the structural example of the hard ware of the printer device 1 in the image output system of the embodiment 1 of the invention. In FIG. 2, CPU 41 is an arithmetic unit for executing a program and executing a process described in the program. ROM 42 is a memory in advance storing the program and the data. RAM 43 is a memory temporarily storing the program and the data when executing this program.

As the program executed by CPU 41, in ROM 42, a non-volatile storage 46 or a not shown other record medium, there are stored a program for processing the image such as color change or half toning to the image data of the image data file, a program for generating control data (printing control command such as ESC/P) for printing from the image data, or a program for control information concerned with the direct printing and processing in accordance with the protocol for transferring the image data.

Besides, in FIG. 2, a print engine 44 is a circuit or a device for controlling the printing mechanism 14 in accordance with the printing control data supplied from CPU 41 and executing the printing process.

USB host-side interface 45 corresponds to the communication circuit 11 of FIG. 1, and is a host-side interface circuit stipulated by USB.

The non-volatile storage 46 is a non-volatile semi-conductor memory as the memory means storing various kinds of configurations and histories thereof. As the memory means, other record medium such as the magnetic record medium may be employed instead of the semi-conductor memory.

A bus 47 is a signal path for alternately connecting CPU 41, ROM 42, RAM 43, the print engine 44, USB host-side interface 45, the non-volatile memory 46, the operation part 15 and the display 16. By the way, the number of piece of the bus 47, and the connecting topologies to the bus 47 of CPU 41, the print engine 44 and others are not limited to those of FIG. 2. The Operation part 15 and the display 16 FIG. 2 are the same as those of FIG. 1.

FIG. 3 is a block diagram showing the structural example of the hard ware of the digital camera 2 in the image output system of the embodiment 1 of the invention. In FIG. 3, CPU 61 is an arithmetic unit for executing the program and executing a process described in the program. ROM 62 is a memory in advance storing the program and the data. RAM 63 is a memory temporarily storing the program and the data when executing this program.

As the program executed by CPU 61, a program for controlling respective parts when photographing or transferring the data, a program for carrying out the control of the information concerned with the direct printing and the process in accordance with the protocol for transferring the image data, and a program for managing the image data file are stored in ROM 62 or a not shown other record medium.

In FIG. 3, the memory card 65 corresponds to the record medium 24 of FIG. 1, and is the record medium of storing the image data acquired by photographing. Instead of the memory card 65, the semi-conductor memory secured inside of the device or the magnetic record device may be served.

USB device-side interface 66 corresponds to the communication circuit 21 of FIG. 1, and is a device-side interface circuit stipulated by USB.

A bus 47 is a signal path for alternately connecting CPU 61, ROM 62, RAM 63, a memory card 65, USB device-side interface 66, the operation part 25, the display 26, and the photographing part 27. By the way, the number of piece of the bus 67, and the connecting topologies to the bus 67 of CPU 61, the print engine 44 and others are not limited to those of FIG. 3. The Operation part 25, the display 26, and the photographing part 27 are the same as those of FIG. 1.

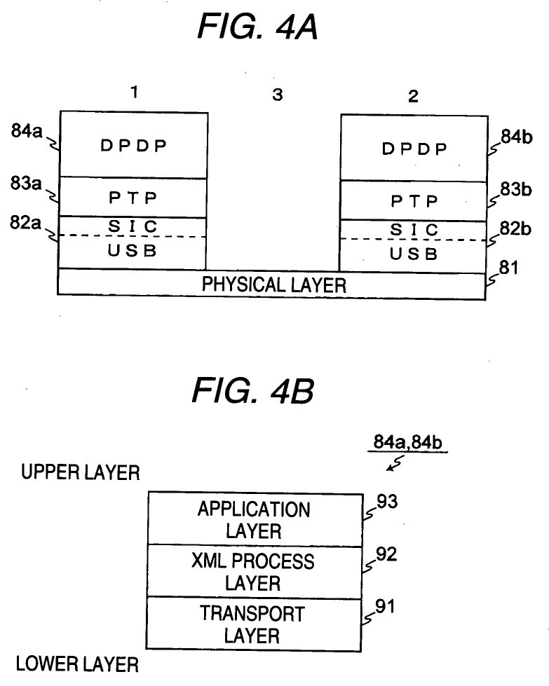

FIGS. 4A and 4B are views showing examples of protocols used between the printer device 1 and the digital camera device 2 in the image output system of the embodiment of the invention. FIG. 4A is a view showing a protocol hierarchical structure; while FIG. 4B is a view showing detailed protocol structure of DPDP layers 84a, 84b.

This embodiment 1 uses, as a physical layer 81, the channel 3 being USB cable, USB host-side interface 45, and a signal transmitting and receiving circuit (not shown) inside of USB device-side interface 66. In the print device 1 and the digital camera device 2 of this embodiment 1, there are, as a layer of controlling the physical layer, USB layers 82a, 82b realized by USB host-side interface 45 and USB device side interface 66, and a still image class (SIC) is used as USB class. Thereby, the data transferring channel is realized. As to the USB standard, USB 1.1 or USB 2.0 are now present, and those of subsequent versions and the followings to be proposed in future are sufficient, or those of communication standards equivalent to USB may be used instead. In case of using USB in the channel 3, the print device is USB host, while the digital camera device 2 is USB device.

At the upper position thereof, the image transfer protocol (PTP) is used, which stipulates the control from the outside of the digital still picture device (DSPD), and the image data transfer to the outside of the digital still picture device (DSPD). PTP layers 83a, 83b are processing parts for transferring the data file on the basis of PTP. As the standard of PTP, there is “PIMA 15740: 2000” of PHOTOGRAPHIC AND IMAGING MANUFACTURES ASSOCIATION, INC. PTP is the protocol of providing the communication system for exchanging the image data in relation with DSPD, and in PTP, the object (such as the image data file) in the storage is designated by an object handle, not by the bus.

This embodiment 1 uses, at the upper position, DPDP layers 84a, 84b which perform transmission and reception of the control information concerned with the printing based on the DPDP protocol being the protocol for carrying out the printing by directly supplying the image data stored in the digital camera device 2 to the printer device 1 via the channel 3. In the DPDP layers 84a, 84b, the control information concerned with the printing process is transmitted and received as a series of script (that is, text data) described in markup language (herein, XML; Extensible Markup Language) via the channel 3 between the printer device 1 and the digital camera device 2. By the way, as the control information concerned with the printing process, there are several kinds of commands, responses to these commands, or notifications of conditions of the devices or the printing job. The above script includes only the control information and does not include the image data files as the objects to be printed. That is, the information of the storing places of the image data files is included in this script, but the image data itself is not included there.

In the above respective protocols, the physical layer 81 is realized in this embodiment 1 by the communication circuit 11, the channel 3 and the communication circuit 21, USB layers 82a, 82b are realized by the communication circuits 11 and 21, and PTP layers 83a, 83b and DPDP layers 84a, 84b are realized by the communication control parts 12 and 22.

In DPDP layers 84a, 84b, for providing the matching between DPDP layers 84a, 84b and the lower layers, there is, at the lowest layers of DPDP layers 84a 84b, provided a transport layer 91 for transmitting and receiving the control information in response to input-output formats (command set and corresponding format) at the lower layer. Therefore, the lower layers of DPDP layers 84a, 84b are not limited to PTP layers 83a, 83b, and it is sufficient to change the transport layer 91 in response to the lower layers thereof.

Further, DPDP layers 84a, 84b have XML processing layer 92 on the transport layer 91 for generating and interpreting XML script including the control information, and further an application layer 93 on XML processing layer 92 for transmitting and receiving the control information so as to progress the direct printing process.

In the embodiment 1, DPDP layers 84a, 84b cooperate each other, designate one data file to one image outputting request for realizing PIF printing function, continuously transfer a plurality of image outputting requests, use the plurality of data files designated in the pluralityof image outputting requests, and carry out the printing of one image.

Herein, the frame insertion printing function (called as “PIF function”) will be explained. In the following, the printing using PIF function will be called as PIF print.

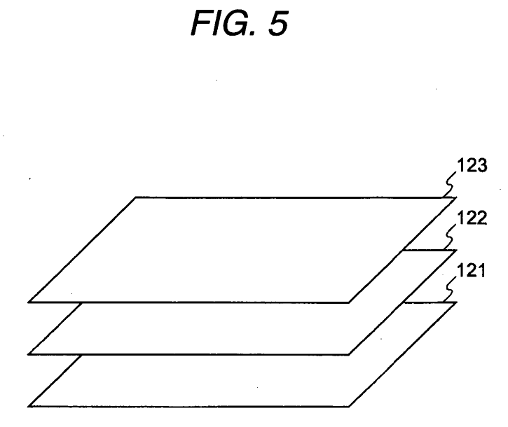

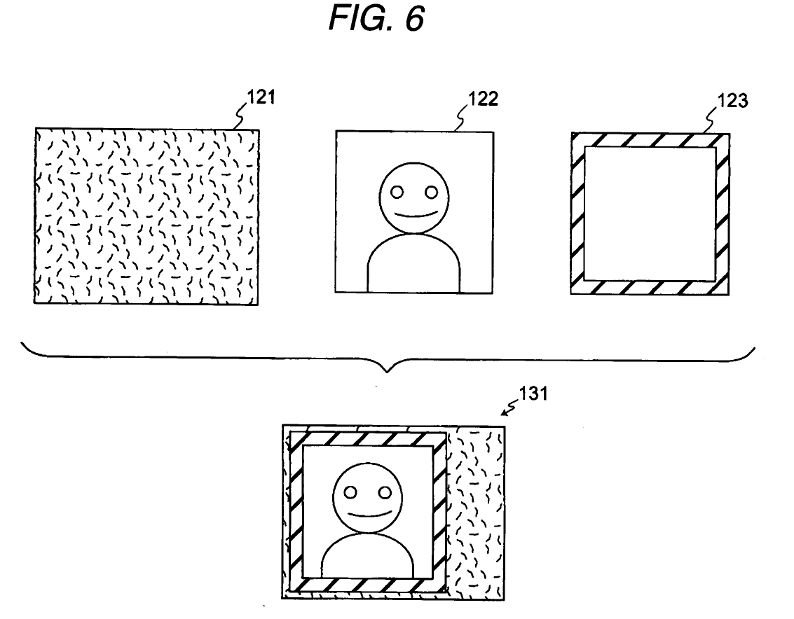

FIG. 5 is a view for explaining the concept of PIF function. FIG. 6 is a view showing examples of printing images of PIF print. If using PIF function, as shown in FIG. 5, the same image area is printed with a plurality of images 121, 122, 123 under the superposed condition. In this case, for example, one image 123 of the images 121, 122, 123 is the frame image, and the frame image data is described with the information concerning the transparent area displaying the other image 122 (for example, the position or transparency of the area). As shown in FIG. 6, the image data of a background image 121, the image data of the main image 122 as the printing object, and the image data 123 as the frame image are composed, and the image data of one sheet of image 131 is generated, and on the basis of this image data, the image 131 after composition is printed.

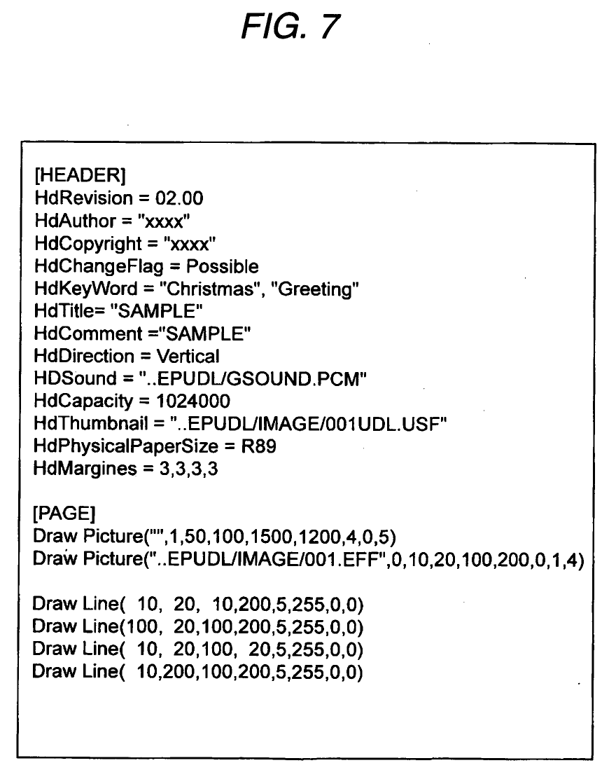

The position of the main image 122 and the layout of the background image and the frame image in the case of PIF print are defined by the layout definition file. FIG. 7 is a view showing examples of the layout definition file. As shown in FIG. 7, the layout definition file is described with a header information (a part beginning with [HEADER]) and a page information (a part beginning with [PAGE]).

The header information includes information concerned with the layout definition file. For example, the header information contains a variable of “HdKeyWord”, a variable of “HdDirection”, a variable of “HdVoice”, a variable of “HdThumbnail”, a variable of “HdPhysicalPaperSize”, or a variable of “HdMargins”.

The variable “HdKeyWord” is a variable having, as a value, a key word especial or desired by a user concerning the page layout. For example, in FIG. 7, the key word is “Christmas” or “Greeting”. This key word can use not only half size alphabetic characters but letters of character code. The layout definition file is searched on the basis of the key word by “HdKeyWord”.

The variable “HdDirection” is a variable having, as a value, a display direction information of the page layout. The display direction is a direction of the page layout when being displayed in the finder or the display of the digital camera, or when printed, for example, a vertical direction or a lateral direction.

The variable “HdSound” is a variable having, as a value, a sound file information, that is, a pointer of the sound file concerned with the layout definition file. The value of the variable “HdSound” is a relative path name (for example, “¥EPUDL¥” as shown in FIG. 7) with, for example, the file name of the sound file (for example, “GSOUND.PCM” as shown in FIG. 7). Instead of the relative path name, a complete path name may be used. In the following, the expression method of the file pointer will be the same as this case. As is seen, the layout definition file may be relative with the sound file, for example, in case this layout definition file is outputted outside, the sound file may be also outputted. The sound file is reproduced at being predetermined. For example, when the page layout described in the layout definition file is displayed in the finder or the display of the digital camera or in the display of the printer, or when a page design including this page layout is printed, such as sound recorded in the voice file is automatically reproduced.

The “HdThumbnail” is a variable having, as a value, a thumbnail information, that is, a pointer of the image data file of the thumbnail image of the page layout. The thumbnail image is made by using a specified device (personal computer, portable telephone, digital camera, or printer). It is also sufficient to display or print a table of a plurality of page layouts arranging the thumbnail images in response to the user' operation.

The variable “HdPhysicalPaperSize” is a variable having, as a value, a paper size completely matching the size of the page layout, when a physical page size information, that is, the page layout is printed.

The variable “HdMargins” is a variable having, as a value, a print margin information, that is, an information showing how much a margin is left for a printing paper. For example, as shown in FIG. 7, in case the values of the variable “HdMargins” is “3, 3, 3, 3”, the printing is performed with margins of 3 mm in the upper, lower, left and right ends of a rectangular sheet. The numerical values of the print margin are not limited to positive values, and may be zero or negative values. In such cases, the printing is done without margin.

The page information in the layout definition file includes concerning the attributes of the page layout. For example, the page information includes a function “Draw Picture”, the function “Draw Strings”, or the function “Draw Line”.

The function “Draw Picture” is a function for drawing images as an argument of information concerning the drawing area.

A first argument of the function “Draw Picture” is an image file pointer relative with the file of a target image applied to the image area. As to a value of the image file pointer of the first argument, in case the target image is decided when generating the layout definition file, said value is the file pointer of this target image, and in case the target image is not yet decided when generating the layout definition file, it is NULL. In case the back ground image 121 applied to the image area of the page layout is in advance decided, the file pointer of this image is described as the first argument. A kind of the applied image may be distinguished by an extension of the file name. For example, in case of the back ground image, the extension is enough with “EFF”. By the way, in case the target image is not yet decided when generating the layout definition file, the target image is designated in a printing job starting command.

A second argument of the function “Draw Picture” is a photo ID of the image area. A value of the photo ID is an integer of 1 or more, in case an applied image is not yet decided, and in case the applied image is already decided, the value of the photo ID is zero.

A third argument to a sixth argument of the function “Draw Picture” are values of X-Y coordinate of two points on the diagonal line showing an external form of a rectangular image area. The external form of the image area is not limited to rectangle but may be polygonal, round or oblong, and a method of showing the external form of the image area is not limited to describing of the coordinate but may be, for example, a function formula showing a boundary line.

A seventh argument of the function “Draw Picture” is a rotating degree information showing a degree of rotating the image applied to the image area. The rotating degree information can be set with a determined scope (for example 0 to 360°).

An eighth argument of the function “Draw Picture” is a numerical value of designating a fitting rule applied to the image. As the fitting rule, irrespective of leaving the margin within the image area, there are a rule of applying the image as it is, or a rule where, as maintaining a ratio of length and breadth desired by a user, the image is applied such that a range desired by the user is displayed, leaving no margin in the image area.

A ninth argument of the function “Draw Picture” is a numerical value of designating a positioning rule of deciding a position arranging the image in the image area. As the positioning rule, there are, for example, matching left upper parts (a method of matching a left upper apex of the image to a left upper apex of the image area), or matching centers (a method of matching a center of the image to a center of the image area).

The function “Draw Line” of the page information is a function of drawing lines applied to the page layout. The function “Draw Line” takes eight arguments, where the first argument and the second argument are the coordinates of beginning line-end, and the third argument and the fourth argument are the coordinate of periphery-end. The fifth argument to the eighth argument are attribute information of the drawn line (thickness of the line and RGB value). In FIG. 7, the fifth argument to the eighth argument are “5, 255, 0, 0”, and the line thickness is five points, and R value of the line color is 255, G value is 0, and B value is 0.

For performing PIF printing, based on the above mentioned layout definition file, a plurality of images 121, 122, 123 are composed by the printer and the composed images are printed.

The communication circuit 11 of the printer device 1 and the communication circuit 21 of the digital camera device 2 function as the communication means for carrying out the data communication. The printing control part 13 and the printing mechanism 14 of the printer device 1 function as the image output means of outputting one image based on a plurality of data files in accordance with the determined image output form (in the embodiment 1, PIF printing form).

DPDP layer 84a of the digital camera device 2 function as the communication control means which controls the communication means and transmits to the printer device 1 the image output request designating, as the image data file, the plurality of data files used for the image output form of outputting one image by using the plurality of data files.

DPDP layer 84b of the printer device 1 functions as control means which acquires, on receiving the image output request by the communication means, parts or all of the plurality of data files designated in the image output request via the communication means from the digital camera device 2, and in case the data file has the determined form, acquires remaining data file if existing via the communication means from the digital camera device 2, controls the image output means, and outputs one image in the image output form based on the plurality of data files designated in the image output request.

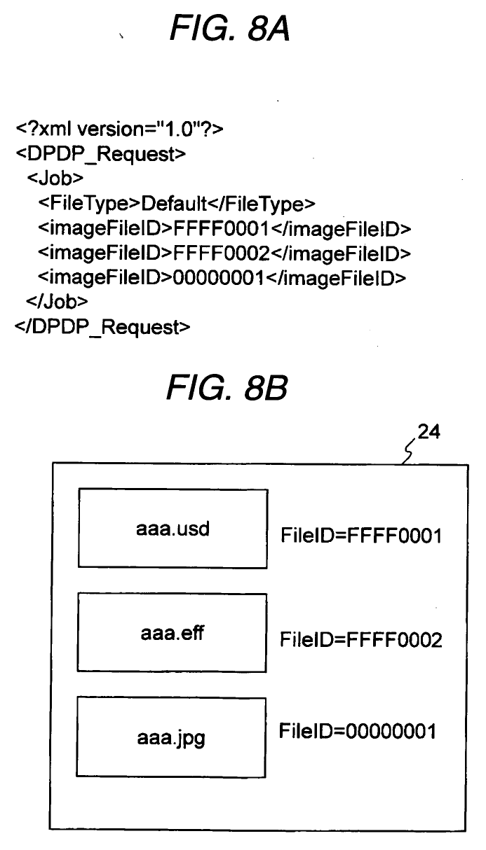

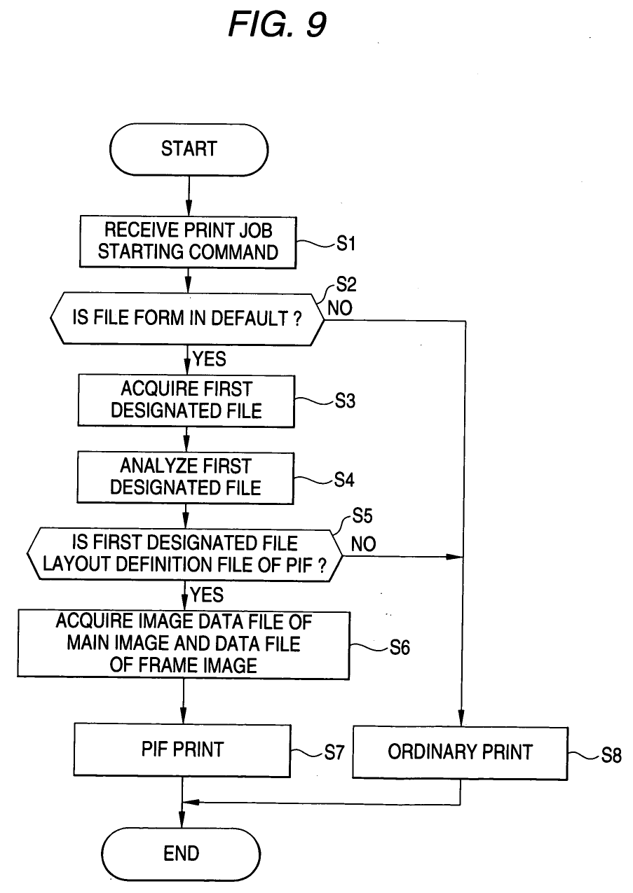

Next, explanation will be made to works of respective devices in the image system of the embodiment 1. FIGS. 8A and 8B are views showing one example of XML script and a set example of the data file of the image output request used at a time of PIF printing in the image system of the embodiment 1. FIG. 9 is a flow chart for explaining the work of the printer device in the image system of the embodiment 1.

In the printer device 1 and the digital camera device 2, after starting, CPU 41, 61 execute programs previously stored in ROM 42, 62. Thereby, in the printer device 1 and the digital camera device 2, the communication control parts 12, 22, the printing control part 13 and the central control part 23 are realized, and the hierarchical processing parts shown in FIGS. 4A, 4B are realized.

After then, when the printer device 1 and the digital camera device 2 are physically connected by the user, at first, a data transmitting path is built on the basis of a still image class between USB layers 82a, 82b by both entities. When the data transmitting path is built by USB, the entities of PTP layers 83a, 83b are started on USB layers 82a, 82b, using the data transmitting path. The entities (main communication bodies) of the respective protocols upper than USB layers 82a, 82b and PTP layers 83a, 83b are realized by the communication control parts 12, 22.

The printer device 1 and the digital camera device 2 store files of respectively decided names (otherwise, pretending to imaginarily store them), and when the files are detected based on PTP by the communication control parts 12, 22, it is detected that a machine responding to DPDP protocol is connected to a communication opponent party. By this connection process, it is guaranteed that that a communicating opponent uses the same protocol as that of this side (herein, DPDP protocol).

By this connection process, when the machine responding to DPDP protocol as the communicating opponent is connected, the communication control parts 12, 22 of the printer device 1 and the digital camera device 2 start the process in accordance with DPDP protocol by DPDP layers 84a, 84b.

By this connection process, when detecting the printer device responding to DPDP protocol as the communicating opponent, DPDP layer 84b of the digital camera device 2 notifies to the printer device 1 the environment information including a version information of DPDP protocol, a vender name of the digital camera device 2, a version information intrinsic to the vender concerning this digital camera device 2, the product name of the digital camera device 2, and the serial number of the digital camera device 2.

When receiving the environment information, DPDP layer 84a of the printer device 1 cooperates with the digital camera device 2 in order to judges whether or not executing the direct printing in accordance with DPDP protocol, and DPDP layer 84a transmits to the digital camera device 2 the response having information showing whether or not receiving the direct printing in accordance with DPDP protocol, the version information of DPDP protocol, the vender name of the printer device 1, the version information intrinsic to the vender concerning this printer device 1, the product name of the printer device 1, and the serial number of the printer device 1. DPDP layer 84b of the digital camera device 2 receives the response including the environment information of the printer device 1.

Then, DPDP layer 84b of the digital camera device 2 generates and transmits the determined control command described in XML script in accordance with DPDP protocol. When receiving the control command, DPDP layer 84a of the printer device 1 generates and transmits XML script as a response including the environment information of this side, in accordance with DPDP protocol.

When DPDP layer 84b of the digital camera device 2 generates and transmits the control command, the information of the control command (such as a kind of command) is given from an application layer 93 to XML layer 92, and XML processing layer 92 generates XML script on the basis of the information, and a transport layer 91 supplies a transfer instruction of this XML script to a lower protocol (herein, PTP). When DPDP layer 84a of the printer device 1 receives the control command, the control command is given as data from the lower protocol (herein, PTP) to the transport layer 91, and XML processing layer 92 extracts the information of the control command from XML script of the control command, and the direct printing application layer 93 executes the process designated based on the information of the control command. In this manner, the control command is transferred between DPDP layers 84a, 84b. Other control information such as response to the control command or information of conditions of the machine or job is transferred in the same manner.

When receiving the response of executing the direct print, DPDP layer 84b of the digital camera device 2 acquires from the printer device 1 information of respectively selecting branches concerning the set items of a plurality of functions provided in the printer device 1. At this time, DPDP layer 84b of the digital camera device 2 transmits the control command being transmitting request of the information of selecting branches. When receiving the control command, DPDP layer 84a of the printer device 1 transmits the response including the information of selecting branches. DPDP layer 84b of the digital camera device 2 receives the response and acquires the information of selecting branches.

When an initial process when connecting is finished, the digital camera device 2 is receivable of the operation by the user concerning the direct printing.

When the user performs a determined operation to the operating part 25 of the digital camera device 2, and inputs a command for PIF printing, DPDP layer 84b of the digital camera device 2 receives this command. DPDP layer 84b of the digital camera device 2 specifies the layout definition file desired by the user (that is, the layout including a frame image and background image) and the image data file for PIF printing on the basis of the user interface by the operating part 25 and the display device.

DPDP layer 84b of the digital camera device 2 generates the layout definition file, the image data file of the main image, and the image output request designating the data file of the frame image. FIG. 8A shows one example of XML script of the image output request at a time of PIF printing. For example, as shown in FIG. 8B, when selecting the layout definition file “a a a. u s d” of the file ID being “F F F F 0 0 0 1”, the layout definition file “a a a. e f f” of the file ID being “F F F F 0 0 0 2”, and the layout definition file “a a a. j p g” of the file ID being “0 0 0 0 0 0 0 1”, XML script shown in FIG. 8A is generated. In XML script shown in FIG. 8A, the layout definition file is designated as the file “0 0 0 0 0 0 0 1” by a imageFileID tag, and the form of this file is set in a default “Default” by FileType tag. The file form of an exclusive data file of the printing intrinsic to the vender as PIF function is not previously defined in DPDP protocol. In case of xx tag, it includes both of <x x tag>and </x x tag>.

DPDP layer 84b of the digital camera device 2 transmits XML script of the image output request by use of processing layers of PTP layer 83b and the following layers. This XML script is transferred to the printer device 1 via the channel 3.

The DPDP layer 84a of the printer device 1 receives XML script of the image output request transferred by PTP layer 83a and the following layers (Step S 1).

The DPDP layer 84a of the printer device 1 analyzes its content to judge whether or not the designation of the file form is defaulted (Step 2).

In case the file for designated in the image output request is defaulted, the DPDP layer 84a of the printer device 1 generates a file transmit request (control command) of the data file initially designated in the image output request, and transmits it to the digital camera device 2. DPDP layer 84b of the digital camera device 2 reads out from the record medium 24 the data file having the file ID designated by the file transmit request, and transmits to the printer device 1. DPDP layer 84a of the printer device 1 receives the data file. In this way, the printer device 1 acquires the file initially designated in the image output request (Step S 3). For example, in the case of XML script shown in FIG. 8A, the data file of the file ID being “F F F F 0 0 0 1” initially described among the designations of the files is at first acquired.

The file transmit request is transferred from the printer device 1 via the channel 3 to the digital camera device 2. The data file is transferred from the digital camera device 2 via the channel 3 to the printer device 1. When DPDP layer 84b of the digital camera device 2 receives XML script of the file transmit request transferred from the process layer of PTP layer 83a and the following, transfers the designated data file (that is, the layout definition file desired by the user) by use of PTP layer 83b. In this process, it is also sufficient to convert the file transfer request of the DPDP protocol into the file transfer request GetObject of the PTP, and perform transferring only with the DPDP layer 84a and the PTP layers 83a, 83b.

In case the file form of the data file designated in the image output request is Default, when acquiring the data file initially designated in the image output request, DPDP layer 84a of the printer device 1 analyzes the content of this file (Step S 4). In this analysis, DPDP layer 84a judges whether or not this data file is the layout definition file of PIF print (Step S 5). For example, on the basis of variable name or the function name used in the layout definition file, the DPDP layer 84a judges whether or not the data file data file is the layout definition file of the PIF print.

When recognizing that this data file is the layout definition file of PIF print, the DPDP layer 84a of the printer device 1 acquires from the digital camera device 2 the remaining data file designated in the image output request (Step S 6). The remaining data file is acquired in the same manner as acquiring the initial data file (Step S 3). In PIF print, as the remaining data file designated in the image output request, there are the data file of the frame image and the data file of the main image. For example, in the case of the image output request shown in FIG. 8A, the data file of the frame image “a a a. e f f” and the image data file of the main image “a a a. j p g” are acquired by the printer device 1.

Based on the layout definition file initially acquired, the data file later acquired, and the image data file of the main image, the DPDP layer 84a of the printer device 1 execute the PIF print by the print control part 13 and the print mechanism 14 (Step S 7). Thereby, one image 131 is printed as shown in FIG. 6.

On the other hand, in Step S 2, in case DPDP layer 84a of the printer device 1 judges that the file form designated in the image output request is not Default, and in case the data file initially designated in the image output request is not the layout definition file of PIF print, DPDP layer 84a specifies one image on the basis of one image data file designated by one imageFileID tag, and outputs this image (Step S8).

As mentioned above, according to the embodiment 1, the digital camera device 2 transmits to the printer device 1 the image output request designating, as the image data file, the plurality of data files used for the PIF print form of outputting one image by use of the plurality of data files. When receiving the image output request, the printer device 1 at first acquires parts or all of the plurality of data files designated in the image output request from the digital camera device 2, and in case the data file has the determined form, acquires the remaining data file if existing from the digital camera device 2, and outputs one image in the image output form based on the plurality of data files designated in the image output request.

Thereby, even in case of employing the descriptive rule designated of one image data file to one image of the image output object in the image output request, in accordance with this descriptive rule, the mutually relative data files are designated by one image output request, so that it is possible to use a plurality of data files and enable to realize an image output process of outputting one image.

Further, according to the above mentioned embodiment 1, when generating the image output request for the image output in the PIF print form, the digital camera device 2 sets in Default the information of the file form designating the data file designated in the image output request. The printer device 1 executes the PIF print, only when the information of the file form designating the data file designated in the image output request is set in Default.

Thereby, if setting in Default the data file designated in the image output request for PIF print, since setting of Default ordinarily exists in the existing descriptive rule, it is unnecessary to clearly designate PIF print, for example, by using an exclusive tag, but it is possible to describe the image output request by the existing descriptive rule. Especially, even in case of the existing descriptive rule is standardized, a producer of the printer device 1 or the digital camera device 2 can offer the printer device 1 or the digital camera device 2 as following this standard.

According to the embodiment 1, the digital camera device 2 designates, as the plurality of data files used for the PIF print form, the layout definition file including layout information of the main image and the frame image, the data file of the frame image and the data file of the main image. Among the plurality of data files used for outputting the image superposing a certain main image and a certain frame image, in case of designating the layout definition file including the layout information of the main image and the frame image on the basis of the image data file of the main image and the data file of the frame image designated in the image output request, the printer device 1 control the image output means In the image output request, and outputs one image superposing the main image and the frame image.

Thereby, even in case of employing a descriptive rule designated of one image data file to one image of the image output object in the image output request, it is possible to realize the image output of superposing the frame image on the main image and outputting it in such as the frame inserting print (PIF print).

Embodiment 2

The image output system according to the embodiment 2 of the invention can allot a plurality of frame inserting images (that is, the images superposing the frame image to the main image) to a certain image output area (for example, page 1) in one image output request.

The embodiment 2 designates one layout definition file with respect to one frame inserting image in the image output request. Accordingly, in case four sheets of frame inserting images are allotted to one page, ordinarily, the four layout definition files are designated in the image output request. Only, for example, in case the same layout definition file is continuously used, repeatedly using frequency n of the layout definition file is designated immediately after designating the layout definition file “<ImageFileID>xxx</ImageFileID>”, and the layout definition file by the repeatedly using frequency may be designated. In this case, an element “<Copy>n</Copy>” using a tag of “Copy” designating the repeatedly using frequency is inserted after “<ImageFileID>xxx</ImageFileID>”.

The printer device 1 acquires each of data files designated in the image output request from the digital camera device 2, analyzes its content, specifies the number of the layout definition files among the plurality of data files designated in the image output request, and generates one frame inserting image based on the respective layout definition files, the data files of the frame images designated by the layout definition files, and the image data file of the main image, and carries out the printing of the plurality of frame inserting images in the arrangement based on the layout designating information designating the layouts of the plurality of images within one page in the image output request.

The basic structure and other works of the printer device 1 and the digital camera device 2 of the embodiment 2 are the same as those of the embodiment 1, and explanation thereof will be omitted.

As mentioned above, according to the embodiment 2, the plurality of frame inserting images can be allotted within one page.

Embodiment 3

The image output system according to the embodiment 3 of the invention uses a definition file connecting the image data file and a voice data file instead of the layout definition file, has, instead of printer device 1, an image display such as a display device with a speaker and a display output device enabling to output voices, stores a music data file in the digital camera device, and transmits the definition file thereof, the image data file designated in the definition file and the voice data file from the image supply device to the image output device, and outputs in parallel the image based on the image data file and the voice based on the voice data file by the image output device.

By the way, in this case, it is sufficient that one voice data file and the plurality of image data files are designated within the definition file so as to output the images in order designated by the image data file, and an image display timing based on the image data file and a display period are designated within the definition file depending on time-passing from start of reproduction of the music.

In the image output request, a dynamic image data file may be designated instead of the voice data file so as to output the still image and the dynamic image in combination.

As mentioned above, according to the embodiment 3, it is possible to combine the image and the voice in one image output request by using the existing descriptive rule, or designate the combination of the still image and the dynamic image for outputting them in parallel.

The above mentioned respective embodiments are the good examples of the invention, but the invention is not limited thereto, and various modifications are available within the scope not exceeding the subject of the invention.

For example, in each of the embodiments, the printer device 1 analyzes the content of the data file and judges the form of the data file, but instead, it is sufficient that the name of the data file (or the name including the path) of the file ID designated in the image output request is acquired from the digital camera device 2 so as to judge the form of the data file based on all or parts (for example, the file expansion) of the name of the data file (or the name including the path).

In case the PTP layers 83a, 83b are mounted, it is possible to acquire the name including the path of the data file as follows. At first, the DPDP layer 84a of the printer device 1 supplies the file ID to the PTP layer 83a so as to issue the command GetObjectInfo designating this file ID as the object handle. When receiving the command GetObjectInfo, the PTP layer 83b of the digital camera device 2 returns as return values the file name corresponding to the object handle and the object handle of the directory. The PTP layer 83a of the printer device 1 gives the return values to the DPDP layer 84a. Thereby, the DPDP layer 84a of the printer device 1 acquires the file name of the file ID and the object handle of the directory. In case it is enough to acquire only the file name of the file ID, the DPDP layer 84a of the printer device 1 finishes here. On the other hand, in case of acquiring the file name of the file ID and the path, the DPDP layer 84a of the printer device 1 designates the object handle of the directory until acquiring a root directory, and repeatedly issue the command GetObjectInfo. Thereby, the file name including the path is acquired.

The above mentioned embodiment describes the control information by use of XML being one of markup languages, and other markup language such as SGML (Standard Generalized Markup Language) may be used to describe.

The above mentioned embodiments use the PTP and USB in the hierarchies of the DPDP protocol and the following, and other protocols such as TCP/IP (Transmission Control Protocol/Internet Protocol) may be used. As the transmitting media at this time, the wired LAN, Bluetooth, or wireless LAN may be used. Further, in the above mentioned embodiments, as the protocol managing and transferring the image data in the digital camera device 2, USB mass storage class may be used instead of PTP.

In the above embodiments, it is possible to use, instead of the printer device 1, other recording devices of recording images on media as papers, the display devices of displaying images, or projector devices of projecting images.

In the above embodiments, the digital camera device 2 is enough with a digital camera for dynamic image and/or still image or various kinds of electronic machinery having such photographing functions. The electronic machinery includes a mobile telephone, PDA, music player, TV receiver, video recording/reproducer, telephone with TV, or TV conference device. The digital camera device 2 may be a device having portability or less portability. Further, instead of the digital camera device 2, the electronic machine without photographing function as mentioned above may be available.

In each of the above embodiments, as an example of outputting one image by use of the plurality of data files including image information, the PIF printing is enumerated, and it is also possible to realize other image outputting processes of outputting one image by use of the plurality of data files including image information

Each of the above mentioned embodiments outputs one image by use of two data files including the image information, and it is also possible to realize other image outputting processes of outputting one image by use of more than three data files.

In the above mentioned embodiments, the layout definition file is firstly designated in the image output request, and it is also sufficient to firstly designate the data file of the frame image, analyze the content of the data file of the frame image.

In the above mentioned embodiments, it is also sufficient not to especially designate the designating order of the layout definition file in the image output request, but to acquire all the data files designated in the image output request, analyze the contents of the respective data files, and carry out the PIF print when any of the data file is designated as the layout definition file.

In the above mentioned embodiments, the outputted image is not limited to the still image, and may be the dynamic image. In this case, instead of the printer device 1, such a device is used which enables to output the dynamic image, for example, the display device.

In the above mentioned embodiments, it is sufficient that the digital camera device 2 confirms the vender of the printer device 1 based on the environment information so as to judge whether transmittance of the image output request for the PIF printing is allowed or prohibited. That is, in case the printer device 1 of the vender employing the PIF printing is connected, the transmittance of the image output request of the PIF printing is allowed, and in case of not, the transmittance is prohibited.

The present invention is available to the direct printing system.

1. An image output method of transferring an image output request and a data file designated by said image output request from an image supply device to an image output device, and outputting an image on the basis of the image output request and the data file by said image output device, comprising
a step of transmitting to said image output device the image output request designating, as the data file, a plurality of data files used for an image output form of outputting one image by using a plurality of data files by means of said image supply device;
a step of, on receiving said image output request by means of said image output device, acquiring parts or all of the plurality of data files designated in the image output request from said image supply device; and
a step, if the acquired data files have a determined form, acquiring the remaining data files if existing from the image supply device by means of said image output device, and outputting one image in the image output form on the basis of the plurality of data files designated in the image output request.

2. An image output method as set forth in claim 1, comprising, when generating the image output request for outputting the image in said image output form, setting in default a file form information designating the form of the data files designated in said image output request by the image supply device.

3. An image output method as set forth in claim 2, comprising, only when setting in default the file form information designating the form of the data file designated in said image output request, acquiring parts or all of the plurality of data files designated in the image output request through communication means from said image supply device by means of said image output device; when the acquired data files have the determined form, acquiring the remaining data files if existing through the communication means from the image supply device by means of said image output device; and controlling said image output means so as to output one image in said image output form on the basis of the plurality of data files designated in said image output request.

4. An image output method as set forth in claim 1, comprising, designating, as a plurality of data files used for the image output form of outputting an image superposing a certain main image and a certain frame image, a layout definition file including layout information of the main image and the frame image, the data file of said frame image, and the data file of said main image in said image output request by means of said image supply device.

5. An image output method as set forth in claim 4, comprising, when designating the layout definition file including the layout information of the main image and the frame image among the plurality of data files used for outputting the image superposing the main image and the frame image in said image output request, controlling said image output means on the basis of the data file, the image data file of said main image designated in said image output request and the data file of said frame image by means of said image output device, so as to output one of images superposing said frame image on said main image.

6. An image output system, comprising an image supply device of transmitting an image output request and a data file designated by said image output request, and an image output device receiving the image output request and the data file designated by said image output request so as to output the image on the basis of the image output request and the data file,
wherein said image supply device transmits to said image output device the image output request designating, as the image data file, a plurality of data files used for an image output form of outputting one image by using a plurality of data files; and
said image output device, when receiving said image output request, acquires parts or all of the plurality of data files designated in the image output request from said image supply device, and when the acquired data files have a determined form, acquires remaining data files if existing from the image supply device, and outputs one image in said image output form on the basis of the plurality of data files designated in said image output request.

7. An image supply device, which receives an image output request and a data file designated by said image output request, and transmits said image output request and said data file to the image output device outputting an image on the basis of said image output request and said data file, comprising
communication means of carrying out data communications in relation with said image output device; and
communication control means of controlling said communication means, and transmitting to said image output device the image output request designating, as an image data file, the plurality of data files used for a image output form outputting one image by using the plurality of data files.

8. An image output device, which receives an image output request and a data file designated by the image output request from an image supply device, and outputs an image on the basis of said image output request and said data file, comprising
communication means of carrying out data communications;
image output means of outputting one image on the basis of a plurality of data files in accordance with a determined image output form; and
control means which, when receiving said image output request by said communication means, acquires parts or all of the plurality of data files designated in the image output request through communication means from said image supply device, and when the data files have a determined form, acquires the remaining data files if existing through said communication means from the image supply device, controls said image output means, and outputs one image in said image output form on the basis of the plurality of data files designated by said image output request.

9. An image output system, comprising an image supply device of transmitting an image output request and a data file designated by said image output request, and an image output device receiving the image output request and the data file designated by said image output request so as to output the image on the basis of the image output request and the data file,
wherein said image supply device transmits to said image output device the image output request designating, as the image data file, a plurality of data files used for an output form of outputting a still image and a dynamic image or an image and a voice in parallel by use of a plurality of data files,
said image supply device, when receiving said image output request, acquires one part or all of the plurality of data files designated in the image output request from said image supply device, and when the acquired data files have the determined form, acquires the remaining data files if being existing from the image supply device, and outputs the still image and the dynamic image or the image and the voice in parallel in said image output form on the basis of the plurality of data files designated in said image output request.

10. A method of providing a data file to be supplied to a printing apparatus employing a descriptive rule requiring designation of one image data file to print corresponding one image, the method comprising the steps of:
selecting first and second image files respectively indicative of first and second images to be superimposed one on another on a sheet;
creating a layout definition file indicative of layout of the first and second images on the sheet;
creating script as the data file to be supplied to the printing apparatus, the script designates:
a predetermined file type used under the descriptive rule;
the layout definition file as an image file;
the first image file as an image file; and
the second image file as an image file,
wherein the predetermined file type designated by the script instructs the printing apparatus to obtain an initial one of the image files designated by the script under the descriptive rule.

11. The method according to claim 10, further comprising:
transmitting the script to the printing apparatus.

12. The method according to claim 10, wherein the predetermined file type is Default, and the script is XML script.

13. A digital camera which supplies a data file to a printing apparatus employing a descriptive rule requiring designation of one image data file to print corresponding one image, the digital camera comprising:
a memory which stores first and second image files respectively indicative of first and second images to be superimposed one on another on a sheet;
a user interface which selects the first and second image files and layout of the first and second images on the sheet;
a communication controller which creates a layout definition file indicative of the layout of the first and second images, and which also creates script as the data file to be supplied to the printing apparatus, the script designates:
a predetermined file type used under the descriptive rule;
the layout definition file as an image file;
the first image file as an image file; and
the second image file as an image file,
wherein the predetermined file type designated by the script instructs the printing apparatus to obtain an initial one of the image files designated by the script under the descriptive rule.

14. The digital camera according to claim 13, further comprising:
a communication circuit which transmits the script to the printing apparatus.

15. The digital camera according to claim 13, wherein the predetermined file type is Default, and the script is XML script.
